(19) United States
(12) Patent Application Publication
(10) Pub. No.: US 2026/0166971 A1
(43) Pub. Date: Jun. 18, 2026

(54) Air Conditioning System for a Motor Vehicle

(71) Applicant: MAHLE International GmbH, Stuttgart (DE)

(72) Inventors: Lukas Pobitzer, Weinstadt (DE); Alexander Bruder, Stuttgart (DE); Holger Laux, Dietingen (DE); Matthias Lohmueller, Tübingen (DE); Matthias Schall, Ostfildern-Ruit (DE); Kerstin Wochele, Friolzheim (DE)

(21) Appl. No.: 19/419,983

(22) Filed: Dec. 15, 2025

(30) Foreign Application Priority Data
Dec. 16, 2024 (DE) 102024137894.8

(51) Int. Cl. B60H 3/02; B01D 53/04; B01D 53/26

(52) U.S. Cl. CPC B60H 3/024; B01D 53/0438; B01D 53/0446; B01D 53/0454; B01D 53/261; B01D 2257/80; B01D 2259/40096; B01D 2259/402; B01D 2259/4566; B60H 2003/028

(57) ABSTRACT

The invention relates to an air conditioner (3) for the interior (2) of a vehicle (1), which has a main channel (4) for conducting air (5) in a main airflow (23) to the vehicle interior (2), wherein the air conditioner (3) contains a dehumidifier (7) for dehumidifying a first subsidiary airflow (24) to the main airflow (23) in the main channel (4), which contains at least one dehumidifying element (10) for dehumidifying the first subsidiary airflow (24) flowing through it, wherein the dehumidifying element (10) is placed in the main channel (4) such that the first subsidiary airflow (24) flows through it, at least during a dehumidifying mode, wherein the dehumidifier (7) has an air supply channel (11) for the dehumidifying element (10), which conducts the first subsidiary airflow (24) from the dehumidifying element (10) to the main channel (4), and an exhaust air channel (12), which conducts a second subsidiary airflow (25) from the dehumidifying element (10) to the exterior (6) of the vehicle (1), wherein the dehumidifying element (10) is configured to be operated in a sorption mode (SB) to accumulate moisture, in which the dehumidified air (5′) in the first subsidiary airflow (24) is conducted through the air supply channel (11) to the main channel (4), and to be operated in a desorption mode (DB), in which the moisture is discharged, such that the dehumidified air (5″) in the second subsidiary airflow (25) is discharged through the exhaust air channel (12) into the vehicle's exterior (6).

### CROSS-REFERENCE TO RELATED APPLICATIONS

This application claims priority from German Patent Application No. DE 102024137894.8, filed on Dec. 16, 2024, the entirety of which is hereby incorporated by reference herein.

The present invention relates to an air conditioner for a vehicle interior.

An air conditioner normally contains a main channel for the main airflow to the vehicle interior, as well as at least one cooler for cooling the air, and at least one heater for heating the air, through each of which air can flow in the main channel. The main channel leads to numerous vents through which the air enters the vehicle interior. This type of air conditioner can be operated in a recirculating mode, in which the air is drawn from the interior and then returned, and in a fresh air mode, in which air is drawn from the exterior and conveyed through the main channel to the interior. These air conditioners can also be operated in a mixed air mode, in which air is drawn from the vehicle's exterior and interior. Some fresh air can also normally be added to the recirculated air in the recirculating mode, to keep the carbon dioxide below a hazardous level in the vehicle interior. Accordingly, the recirculating mode is normally a mixed-air mode to a certain extent.

To make the vehicle as efficient as possible, the air conditioner must consume as little energy as possible. In particular when it is cold outside, it makes sense to reuse as much previously heated air as possible to heat the vehicle interior. Consequently, more recirculated air is used when it is cold outside.

People or moist objects in the vehicle contribute significantly to the humidity in the recirculating air, i.e. the portion of water or vapor therein, in the recirculating mode.

Particularly in cold weather, this raises the probability of condensation accumulating on the windows. To prevent this, more relatively dry fresh air needs to be added during the recirculating mode. This impacts the efficiency of the air conditioning, because the fresh air needs to be heated.

Warmer outside temperatures can also lead to higher humidity levels inside the vehicle when it is humid outside. With conventional air conditioning, a reheating mode can be used in this case, in which warm and humid outside air is cooled in the air conditioner to below the dew point, to condense the moisture to the liquid state, which can then be effectively removed. The resulting dehumidified air is then reheated before it is supplied to the vehicle interior. Cooling and reheating air requires a lot of energy.

The object of the present invention is to create an air conditioner that is better, or at least different than that described above, which therefore functions more efficiently.

This problem is solved with the invention by the subject matter of the independent Numbered Paragraphs. Advantageous embodiments are the subject matter of the dependent Numbered Paragraphs.

The invention is based on the general concept of dehumidifying the air supplied to the vehicle interior with a dehumidifier, thus reducing the probability of condensation accumulating on the windows, even when there is little or no fresh air therein and it is cold outside. This can be achieved with a large portion of recirculated air when it is cold outside, and with a large portion of fresh air when it is warm outside. With a larger portion of recirculated air, only a little of the cold fresh air has to be heated, increasing the efficiency of the air conditioner obtained with the invention. This dehumidifier can also be used in the fresh air mode to dehumidify fresh air without it having to be cooled first and then reheated, thus also increasing the efficiency of the air conditioner.

In detail, it is proposed that the air conditioner contain a dehumidifier for dehumidifying a first subsidiary airflow of the main airflow in the main channel, which contains at least one dehumidifying element for dehumidifying this first subsidiary airflow passing through it. This dehumidifying element is placed in the main channel such that at least during the dehumidifying mode the first subsidiary airflow branches off from the main airflow and flows through it. The dehumidifier has an air supply channel for the dehumidifying element which conducts the first subsidiary airflow from the dehumidifying element back to the main channel, and an exhaust air channel, that conducts a second subsidiary airflow, which also branches off from the main airflow in the main channel, from the dehumidifying element to the exterior of the vehicle. This dehumidifying element is configured to be operated in a sorption mode in which the dehumidified air in the first subsidiary airflow is conducted to the main channel through the air supply channel, and in a desorption mode, in which humidified air in the second subsidiary airflow is discharged into the exterior through the exhaust air channel. In other words, the dehumidifying element removes moisture from the air through adsorption or absorption during the sorption mode, to obtain air that is more or less dehumidified.

In this context, the term “sorption” is used in general for sequences that result in adsorption or absorption, and can also include processes where it is not possible to clearly distinguish between adsorption and absorption. The dehumidifying element is made of a sorption material and/or is coated with a sorption material. This material accumulates moisture or water. The sorption material can be a moisture or water adsorbing material or absorbing material. This configuration could conceivably contain both an adsorbing material and an absorbing material.

In the desorption mode, the moisture accumulated in the dehumidifying element is discharged into the air flowing through it, thus humidifying this air. In this case, the humidified air is discharged through the exhaust air channel into the exterior. This removes moisture from the air supplied to the vehicle interior, thus discharging a higher concentration of moisture, i.e. with less air, into the exterior. It should be noted that the dehumidifier does not require external energy to function in the sorption mode. This dehumidifying also has little or no effect on the temperature of the air, such that the dehumidifier is substantially isothermal, resulting in a dehumidifying mode for isothermal dehumidification of the air, or first subsidiary airflow.

In an advantageous embodiment, the air conditioner can be operated in this dehumidifying mode during a recirculating mode, a fresh air mode, and/or a mixed air mode, to dehumidify the first subsidiary airflow, in which the first and second subsidiary airflows branch off from the main airflow such that the first subsidiary airflow, containing dehumidified air, is returned to the main airflow downstream of the dehumidifier, and the second subsidiary airflow, containing the humidified air, is discharged into the exterior.

This air conditioner can also have a control unit coupled to the dehumidifier. The dehumidifier, or the dehumidifying element, can be regulated therewith. The control unit also switches the dehumidifying element back and forth between the sorption mode and desorption mode in the dehumidifying mode. The air conditioner obtained with the invention can be operated in the recirculating mode with an extremely low portion of fresh air when it is cold outside, such that very little fresh air has to be heated. Consequently, the air conditioner is more efficient. The portion of fresh air can depend on the portion of carbon dioxide in the recirculating air, which in turn depends on the number and constitution of the people in the vehicle. Efficient dehumidification can also be obtained in the fresh air mode and in the mixed air mode.

In the present context, a configuration is the same as a design, arrangement, and/or programming, such that the formulation, “configured such” means the same as “designed such,” arranged such,“ and/or ”programmed such.“

The control unit can also be configured to only activate the dehumidifier when the outside temperature is below or above predefined threshold values.

The dehumidifier and the dehumidifying element are components that can be regulated or operated electronically by the control unit. The moisture in the air is water or water vapor in this context.

In a particularly advantageous design, the dehumidifier can contain at least two such dehumidifying elements, both of which are connected to the main channel at the intake end. Both dehumidifying elements have at least one air supply channel and one exhaust air channel at their outlet ends, through which the air from the respective dehumidifying elements is discharged. Each dehumidifier also has a shutter system for the air supply channel and exhaust air channel. This shutter system can also be regulated or operated electronically. The shutter system can be switched between a first and second setting. In the first setting, the first dehumidifying element is connected to the air supply channel and the second is connected to the exhaust air channel. In the second setting, the second dehumidifying element is connected to the air supply channel, and the first is connected to the exhaust air channel. This allows one dehumidifying element to dehumidify the first subsidiary airflow, while the other is regenerated with the second subsidiary airflow. Consequently, air can be constantly dehumidified by switching back and forth between the two elements.

The control unit can be configured to switch the shutter system back and forth between the first and second settings. In the first setting, the first dehumidifying element is operated in the sorption mode and the second is operated in the desorption mode, and in the second setting, the first element is operated in the desorption mode and the second is operated in the sorption mode. Consequently, one of the two dehumidifying elements is always operating in the sorption mode while the other is operating in the desorption mode. Therefore, the air in the first subsidiary airflow is always being dehumidified by one of the dehumidifying elements while the other is being regenerated by the air in the second subsidiary airflow.

The two dehumidifying elements can be connected to the same air supply channel and same exhaust air channel. In this case, the shutter system can be configured to connect the first dehumidifying element to the air supply channel and the second to the exhaust air channel in the first setting, and connect the first dehumidifying element to the exhaust air channel and the second to the air supply channel in the second setting. The two dehumidifying elements can also have separate air supply and exhaust air channels, such that the first is connected to a first air supply channel and first exhaust air channel, while the second is connected to a second air supply channel and second exhaust air channel. This results in a particularly simple and reliable design of the dehumidifier.

The shutter system can contain two separate shutter units, one for the first air supply channel and first exhaust air channel and a second for the second air supply channel and second exhaust air channel. These shutter units can also be regulated electronically by the control unit. The shutter units can each be shifted back and forth between first and second positions, in which the air supply channel is open when the exhaust air channel is closed, or vice versa. The control unit can thus be configured such that the first shutter unit is in the first position and second is in the second position in the first setting, while the first shutter unit is in the second position, and the second is in the first position in the second setting. This results in a simple design that is extremely reliable.

The dehumidifying element can contain at least one hygroscopic element through which air can pass, with an electric heater that is shut off during the sorption mode and switched on for the desorption mode. In this case, the control unit is configured to switch off the heater in the sorption mode, and switch it on in the desorption mode. This electric heater heats the respective dehumidifying element for the desorption mode, such that the moisture therein can be more effectively discharged.

The dehumidifying element can be a ceramic element. This results in a particularly simple hygroscopic element.

Ideally, the element is a semiconductor element, specifically a ceramic semiconductor element with a positive temperature coefficient. This PTC semiconductor element has an integrated heater that forms the dehumidifying element. This PTC semiconductor element is extremely reliable. PTC stands for positive temperature coefficient.

The element can have a hygroscopic coating. This hygroscopic coating on a PTC semiconductor element improves the moisture-sorption capacity of the element.

Ideally, the control unit can switch the shutter system back and forth at a specific frequency during the dehumidifying mode. This results in a particularly reliable operation of the air conditioner.

The control unit can also be configured to switch the shutter system back and forth during the dehumidifying mode based on the degree of sorption in the dehumidifying element operated in the sorption mode. The degree of sorption refers to the amount of moisture accumulated in or on the respective dehumidifying element. By monitoring the degree of sorption, the shutter system can be switched back and forth as needed, e.g. if the degree of sorption exceeds a predefined threshold value, at which point the dehumidifying element can no longer effectively dehumidify the recirculating air to the desired extent.

The control unit can also be configured to switch the shutter system back and forth in the dehumidifying mode based on the humidity in the air in the air supply channel for the dehumidifying element operated in the sorption mode. In other words, the humidity in the dehumidified air is monitored and compared with a predefined threshold value. As soon as the humidity reaches the threshold value, the shutter system is switched to the other setting, such that the saturated dehumidifying element is switched to the desorption mode for regeneration, while the regenerated dehumidifying element is then switched to the sorption mode.

The dehumidifier can contain sensors for detecting the degree of sorption in a dehumidifying element, and/or for detecting the humidity in the air in the recirculating channel for the dehumidifying element operated in the sorption mode. The control unit can be connected to these sensors such that it receives current values for the degree of sorption, or the humidity level, and can compare them with corresponding threshold values. The sensors can be placed basically anywhere in the air conditioner or motor vehicle.

Other features and advantages of the invention can be derived from the dependent claims, drawings, and descriptions thereof.

It is understood that the features specified above and described below can be used not only in the given combinations, but also in other combinations or in and of themselves, without abandoning the scope of protection for the present invention. Components of a higher-order unit specified herein, e.g. an element, device, or assembly, that are referred to separately, can be separate components of this unit, or form integral parts or sections thereof, even if otherwise indicated in the drawings.

Preferred exemplary embodiments of the invention are shown in the drawings, and shall be explained in greater detail below, in which the same reference symbols are used for identical, similar, or functionally identical components.

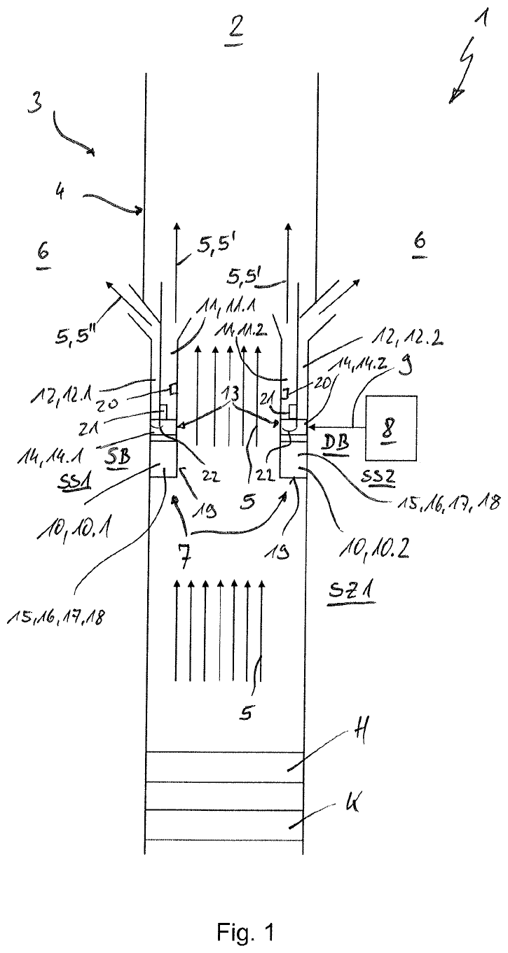

Therein, schematically:
FIG. 1 shows a highly simplified illustration of the part of a motor vehicle containing the air conditioner, in a first operating state, and

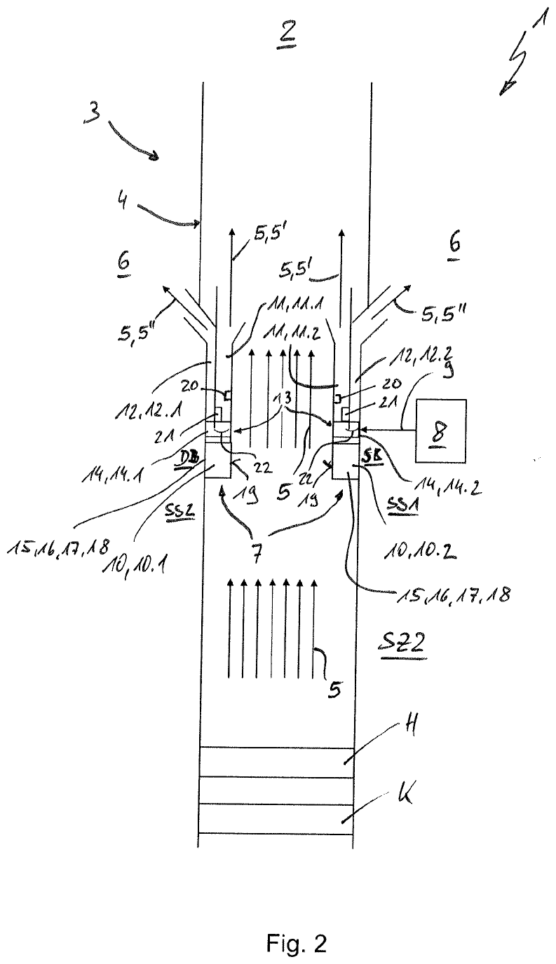

FIG. 2 shows the same as FIG. 1, but in a second operating state of the air conditioner.

As shown in the figures, the motor vehicle 1 has an interior 2 and an air conditioner 3 for the interior 2. The air conditioner 3 has a main channel 4 for the air 5 in a main airflow 23 to the vehicle interior 2. The air 5 and the main airflow 23 are indicated by arrows in the drawings.

The air conditioner 3 can be operated in a recirculating mode, fresh air mode, and mixed air mode. In the recirculating mode, most or all of the air 5 is drawn from the vehicle interior 2 and returned thereto through the main channel 4. This air 5, which can also be referred to as recirculating air, can be supplied to the vehicle 1 more or less from outside 6, which can also be referred to as fresh air. In the fresh air mode, the air is more or less drawn from the outside 6 and supplied to the interior 2 through the main channel 4. In the mixed air mode, some of the air 5 comes from outside 6, and some comes from the interior 2, and is supplied to the interior 2 through the main channel 4.

The air conditioner can also have a heater H through which the air 5 can flow in order to heat it. The air conditioner 3 can also have a cooler K through which the air 5 can flow in order to cool it.

This air conditioner 3 has a dehumidifier 7 for dehumidifying the air 5 in a first subsidiary airflow 24, which is indicated in the drawings by an arrow. The dehumidifier 7 can therefore dehumidify the first subsidiary airflow in a dehumidifying mode. The dehumidifier 7 can be regulated by a control unit 8 connected to it by a control line 9, for example. The control unit 8 controls or operates the air conditioner 3, such that it is in the dehumidifying mode during the recirculating mode, fresh air mode, and/or mixed air mode.

The dehumidifier 7 has at least one dehumidifying element 10 with which the first subsidiary airflow 24 is dehumidified when flowing through it. The control unit 8 is connected to the dehumidifying element 10. The dehumidifying element 10 is in the main channel 4 such that at least in the dehumidifying mode the first subsidiary airflow 24, which branches off from the main airflow 23 in the main channel 4, flows through the dehumidifying element 10. The first subsidiary airflow 24 flowing through the dehumidifying element 10 can form 5% or 10% of the air 5 flowing through the main channel 4.

The dehumidifying element 10 can be operated in a sorption mode SB and in a desorption mode DB. The dehumidifying element 10 accumulates moisture from the air 5 flowing through it in the sorption mode SB. This air 5 flowing through the dehumidifying element 10 consequently becomes dehumidified air 5′. The moisture is then discharged into the air 5 flowing through the dehumidifying element 10 that is in the desorption mode DB. This air 5 consequently become humidified air 5″. The dehumidifier 7 has an air supply channel 11 and an exhaust air channel 12 for the dehumidifying element 10. The air supply channel 11 returns the air 5 from the dehumidifying element 10, i.e. the dehumidified air 5′ in a first subsidiary airflow 24, to the main channel 4. The exhaust air channel 12 conducts the air 5 from the other dehumidifying element 10, i.e. the humidified air 5″, into a second subsidiary airflow 25, indicated by an arrow in the drawings, which is discharged into the vehicle's exterior 6.

The control unit 8 is configured to switch the dehumidifying element 10 back and forth between the sorption mode AD and the desorption mode DB in the dehumidifying mode. In the sorption mode SB, the dehumidifying element 10 dehumidifies the air 5 in the first subsidiary airflow 24, and conducts this dehumidified air 5′ to the air supply channel 11, through which it is supplied to the main channel 4. In other words, the first subsidiary airflow 24 is returned and added to the main airflow 23. At the same time, the air 5 in the second subsidiary airflow 25, which also branches off from the main airflow 23, is used to regenerate the dehumidifying element 10, thus humidifying this air 5, to obtain humidified air 5″, which is then discharged through the exhaust air channel 12 into the vehicle's exterior 6.

In the particularly advantageous embodiment shown here, the dehumidifier 7 has at least two such dehumidifying elements 10, specifically a first dehumidifying element 10.1 and a second dehumidifying element 10.2. Both dehumidifying elements 10 are connected at their intake ends to the main channel 4. The intake ends of the dehumidifying elements 10 face into the main airflow 23, and are at the bottoms of the dehumidifying elements 10 in the drawings. At the outlet ends, both dehumidifying elements 10 have at least one air supply channel 11 and at least one exhaust air channel 12. The outlet ends of the dehumidifying elements 10 face in the downstream direction of the main airflow 23, and are at the tops of the dehumidifying elements 10 in the drawings. The dehumidifier 7 also has a shutter system 13 that regulates the air supply channels 11 and exhaust air channels 12. This shutter system 13 can be switched back and forth between a first setting SZ1, shown in FIG. 1, and a second setting SZ2, shown in FIG. 2. In the first setting SZ1, the first dehumidifying element 10.1 is connected to the air supply channel 11, and the second dehumidifying element 10.2 is connected to the exhaust air channel 12. In the second setting SZ2, the second dehumidifying element 10.2 is connected to the air supply channel 11, while the first dehumidifying element 10.1 is connected to the exhaust air channel 12. The control unit 8 switches the shutter system 13 back and forth between the first setting SZ1 and second setting SZ2 in the dehumidifying mode. Furthermore, in the first setting SZ1, during the dehumidifying mode shown in FIG. 1, the control unit 8 operates the first dehumidifying element 10.1 in the sorption mode SB and the second dehumidifying element in the desorption mode DB. During the dehumidifying mode shown in FIG. 2, in the second setting SZ2, the control unit 8 operates the first dehumidifying element 10.1 in the desorption mode DB, and the second dehumidifying element 10.2 in the sorption mode SB.

In this embodiment, the dehumidifying elements 10 have separate air supply channels 11 and separate exhaust air channels 12, i.e. the first dehumidifying element 10.1 has a first air supply channel 11.1 and first exhaust air channel 12.1, while the second dehumidifying element 10.2 has a second air supply channel 11.2 and second exhaust air channel 12.2. In this case, the shutter system 13 has two separate shutter units 14, a first shutter unit 14.1 for the first air supply channel 11.1 and first exhaust air channel 12.1, and a second shutter unit 14.2 for the second air supply channel 11.2 and second exhaust air channel 12.2. The two shutter units 14 can be shifted back and forth between a first and second position SS1 and SS2. Each shutter unit 14 can have a shutter 22 that can be moved back and forth between the two settings SS1 and SS2. The air supply channel 11 is open in the first setting, and the exhaust air channel 12 is closed. Specifically, the shutter 22 closes the exhaust air channel 12 and opens the air supply channel 11 in the first position SS1. In the second position SS2, the air supply channel 11 is closed and the exhaust air channel 12 is open. Specifically, the shutter 22 closes the air supply channel 11 and opens the exhaust air channel 12 in the second position SS2. The control unit 8 is configured to shift the first shutter unit 14.1 to the first position SS1 and second shutter unit 14.2 to the second position SS2 to obtain the first setting SZ1, shown in FIG. 1. In this setting SZ1, the first subsidiary airflow 24 flows through the first dehumidifying element 10.1, which is in the sorption mode SB, and is dehumidified. The second subsidiary airflow 25 for the first dehumidifying element 10.1 is inactive in the first setting SZ1, and is indicated by an arrow with a broken line. Furthermore, the second subsidiary air flow 25 flows through the second dehumidifying element 10.2, which is in the desorption mode DB in the first setting SZ1, and is humidified. The first subsidiary airflow 24 for the second dehumidifying element 10.2 is inactive in the first setting SZ1, and is indicated by an arrow with a broken line in FIG. 1. To obtain the second setting SZ2, shown in FIG. 2, the control unit 8 shifts the first shutter unit 14.1 to the second position SS2 and the second shutter unit 14.2 to the first position SS1. In this setting SZ2, the first subsidiary airflow 24 flows through the second dehumidifying element 10.2, which is in the sorption mode SB, and is dehumidified. The second subsidiary airflow 25 for the second dehumidifying element 10.2 is inactive in the second setting SZ2, and is indicated by an arrow with a broken line in FIG. 2. Furthermore, the second subsidiary airflow 25 flows through the first dehumidifying element 10.1, which is in the desorption mode DB in the second setting SZ2, and is humidified. The first subsidiary airflow 24 for the first dehumidifying element 10.1 is inactive in the second setting SZ2, and is indicated by an arrow with a broken line in FIG. 2.

Each dehumidifying element 10 has a hygroscopic element 15 with an electric heater 15 through which air can flow. The control unit 8 is connected to the electric heaters 15, and switches them off for the sorption mode SB and on for the desorption mode DB. The element 15 is preferably a ceramic semiconductor element 17 with a positive temperature coefficient, thus forming a PTC element 18. The element 15 can have a hygroscopic coating 19 to obtain the hygroscopic function. Each element 15 can have at least one channel through which air can flow, thus flowing through the dehumidifying elements 10. Ideally, the element 15 has numerous channels. In particular, the element 15 can have a honeycomb structure.

The dehumidifier 7 can contain sensors 20 for detecting the degree of sorption in the dehumidifying element 10 when in the sorption mode SB, and/or to detect humidity in the air 5 in the air supply channel 11 for the dehumidifying element 10 operated in the sorption mode SB. The control unit 8 is connected to these sensors 20. The control unit 8 can also be configured to switch the shutter system 13 back and forth between the first and second settings SZ1 and SZ2 during the recirculating mode at a predefined frequency, and/or based on the degree of sorption for the dehumidifying element 10 operated in the sorption mode SB, and/or based on the humidity in the air 5 in the air supply channel 11 for the dehumidifying element 10 operated in the sorption mode SB.

The dehumidifier 7 can have at least one actuator 21 for switching the shutter system 13 between the two settings SZ1 and SZ2. There are two actuators 21 in this embodiment, each of which shifts one shutter unit 14 between the two settings SS1 and SS2. The control unit 8 is connected to each actuator 21 by a control line 9. The control unit 8 is configured to switch shutter system 13 back and forth between the first setting SZ1 and second setting SZ2, and therefore shift the two shutter units 14 between the two settings SS1 and SS2 with the actuator 21 in the recirculating mode.

FIG. 1 shows the air conditioner 3 in a first operating mode, in which the shutter system 13 is in the first setting SZ1, such that the first shutter unit 14.1 assumes the first position SS1, and the second shutter unit 14.2 assumes the second position SS2. Consequently, the first exhaust air channel 12.1 and second air supply channel 11.2 are closed, while the first air supply channel 11.1 and second exhaust air channel 12.2 are open. At the same time, the first dehumidifying element 10.1 is operated in the sorption mode SB in this first setting SZ1, while the second dehumidifying element 10.2 is operated in the desorption mode DB. Consequently, the first subsidiary airflow 24 is active in the first dehumidifying element 10.1, while the second subsidiary airflow 25 is inactive there, and the second subsidiary airflow 25 is active in the second dehumidifying element 10.2, while the first subsidiary airflow 24 is inactive there. The air conditioner 3 is shown in a second operating mode in FIG. 2, in which the shutter system 13 is in the second setting SZ2, such that the first shutter unit 14.1 assumes the second position SS2, while the second shutter system 14.2 assumes the first position SS1. Consequently, the second exhaust air channel 12.2 and first air supply channel 11.1 are closed, while the second air supply channel 11.2 and first exhaust air channel 12.1 are open. Furthermore, the first dehumidifying element 10.1 is operated in the desorption mode DB in the second setting SZ2, while the second dehumidifying element 10.2 is operated in the sorption mode SB. Consequently, the second subsidiary airflow 25 is active in the first dehumidifying element 10.1, while the first subsidiary airflow 24 is inactive, and the first subsidiary airflow 24 in the second dehumidifying element 10.2 is active, while the second subsidiary airflow 25 is inactive there.

The specification can be readily understood with reference to the following Numbered Paragraphs:

Numbered Paragraph 1. An air conditioner (3) for the interior (2) of a vehicle (1), which has a main channel (4) for conducting air (5) in a main airflow (23) to the vehicle interior (2),
wherein the air conditioner (3) contains a dehumidifier (7) for dehumidifying a first subsidiary airflow (24) to the main airflow (23) in the main channel (4), which contains at least one dehumidifying element (10) for dehumidifying the first subsidiary airflow (24) flowing through it,
wherein the dehumidifying element (10) is placed in the main channel (4) such that the first subsidiary airflow (24) flows through it, at least during a dehumidifying mode,
wherein the dehumidifier (7) has an air supply channel (11) for the dehumidifying element (10), which conducts the first subsidiary airflow (24) from the dehumidifying element (10) to the main channel (4), and an exhaust air channel (12), which conducts a second subsidiary airflow (25) from the dehumidifying element (10) to the exterior (6) of the vehicle (1),
wherein the dehumidifying element (10) is configured to be operated in a sorption mode (SB) to accumulate moisture, in which the dehumidified air (5′) in the first subsidiary airflow (24) is conducted through the air supply channel (11) to the main channel (4), and to be operated in a desorption mode (DB), in which the moisture is discharged, such that the humidified air (5″) in the second subsidiary airflow (25) is discharged through the exhaust air channel (12) into the vehicle's exterior (6).

Numbered Paragraph 2. the Air Conditioner (3) According to Numbered Paragraph 1, characterized in that
the air conditioner (3) is configured to be operated in a dehumidifying mode during a recirculating mode, and/or during a fresh air mode, and/or during a mixed air mode, in which
the first subsidiary airflow (24) and second subsidiary airflow (25) branch off from the main airflow (23),
the first subsidiary airflow (24), containing the dehumidified air (5′), is returned to the main airflow (23) downstream of the dehumidifier (7), and
the second subsidiary airflow (25), containing the humidified air (5″) is discharged into the vehicle exterior (6).

Numbered Paragraph 3. The air conditioner (3) according to either of the preceding Numbered Paragraphs, characterized in that
the air conditioner (3) has a control unit (8), which is connected to the dehumidifier (7), and
the control unit (8) is configured to operate the air conditioner (3) in the dehumidifying mode in which the dehumidifying element (10) is switched back and forth between the sorption mode (SB) and the desorption mode (DB).

Numbered Paragraph 4. The air conditioner (3) according to any of the preceding Numbered Paragraphs, characterized in that
the dehumidifier (7) contains at least two such dehumidifying elements (10), a first dehumidifying element (10.1) and a second dehumidifying element (10.2), both of which are connected at the intake end to the main channel (4),
the two dehumidifying elements (10) are connected at the outlet end to at least one such air supply channel (11) and at least one such exhaust air channel (12),
the dehumidifier (7) has a shutter system (13) for regulating the air supply channels (11) and exhaust air channels (12), that can be switched back and forth between a first setting (SZ1) and second setting (SZ2),
in the first setting (SZ1), the first dehumidifying element (10.1) is connected to its air supply channel (11), while the second dehumidifying element (10.2) is connected to its exhaust air channel (12),
in the second setting (SZ2), the second dehumidifying element (10.2) is connected to its air supply channel (11), while the first dehumidifying element (10.1) is connected to its exhaust air channel (12).

Numbered Paragraph 5. The air conditioner (3) according to Numbered Paragraphs 3 and 4, characterized in that
the control unit (8) is configured to switch the shutter system (13) back and forth between the first setting (SZ1) and second setting (SZ2) in the dehumidifying mode,
the control unit (8) is also configured to operate the first dehumidifying element (10.1) in the sorption mode (SB) and the second dehumidifying element (10.2) in the desorption mode (DB) when in the first setting (SZ1) in the dehumidifying mode, while operating the first dehumidifying element (10.1) in the desorption mode (DB) and the second dehumidifying element (10.2) in the sorption mode (SB) when in the recirculating mode in the second setting (SZ2).

Numbered Paragraph 6. The air conditioner (3) according to Numbered Paragraph 4 or 5, characterized in that the two dehumidifying elements (10) each have separate air supply channels (11) and separate exhaust air channels (12) at their outlet ends, such that the first dehumidifying element (10.1) has a first air supply channel (11.1) and first exhaust air channel (12.1), while the second dehumidifying element (10.2) has a second air supply channel (11.2) and second exhaust air channel (12.2).

Numbered Paragraph 7. The air conditioner according to Numbered Paragraph 6, characterized in that
the shutter system (13) has two separate shutter units (14), a first shutter unit (14.1) and second shutter unit (14.2), for regulating the first air supply channel (11.1) and first exhaust air channel (12.1), and a second shutter unit (14.2) for regulating the second air supply channel (11.2) and second exhaust air channel (12.2),
the two shutter units (14) can be shifted back and forth between a first position (SS1), in which its air supply channel (11) is open and its exhaust air channel (12) is closed, and a second position (SS2), in which its air supply channel (11) is closed, and its exhaust air channel (12) is open.

Numbered Paragraph 8. The air conditioner according to the Numbered Paragraphs 3 and 7, characterized in that the control unit (8) is configured to shift the first shutter unit (14.1) to the first position (SS1) and the second shutter unit (14.2) to the second position (SS2) to obtain the first setting (SZ1), and to shift the first shutter unit (14.1) to the second position (SS2) and the second shutter unit (14.2) to the first position (SS1) to obtain the second setting (SZ2).

Numbered Paragraph 9. The air conditioner (3) according to any of the preceding Numbered Paragraphs, characterized in that
the dehumidifying elements (10) contain hygroscopic elements (15) with electric heaters (16) through which air (5) can flow, and
the heaters (16) are switched off in the sorption mode (SB) and switched on in the desorption mode (DB).

Numbered Paragraph 10. The air conditioner (3) according to Numbered Paragraph 9, characterized in that the element (15) is ceramic.

Numbered Paragraph 11. The air conditioner (3) according to Numbered Paragraph 9 or 10, characterized in that the element (15) is a semiconductor element with a positive temperature coefficient.

Numbered Paragraph 12. The air conditioner (3) according to any of the Numbered Paragraphs 9 to 11, characterized in that the element (15) has a hygroscopic coating (19).

Numbered Paragraph 13. The air conditioner (3) according to Numbered Paragraphs 3 or according to Numbered Paragraph 3 and any of the Numbered Paragraphs 2, and 4 to 12, characterized in that the control unit (8) is configured to
switch the shutter system (13) back and forth between the first setting (SZ1) and second setting (SZ2) at a predefined switching frequency when in the dehumidifying mode, and/or
switch the shutter system (13) back and forth between the first setting (SZ1) and second setting (SZ2) based on a degree of sorption of the dehumidifying element (10) operated in the sorption mode (SB) when in the dehumidifying mode, and/or
switch the shutter system (13) back and forth between the first setting (SZ1) and second setting (SZ2) based on the humidity in the air in the air supply channel (11) for the dehumidifying element (10) operated in the sorption mode (SB) when in the dehumidifying mode.

Numbered Paragraph 14. the air conditioner (3) according to Numbered Paragraph 13, characterized in that
the dehumidifier (7) has sensors (20) for detecting the degree of sorption in the dehumidifying element (10) operated in the sorption mode (SB), and/or to detect the humidity in the air (5) in the air supply channel (11) for the dehumidifying element (10) operated in the sorption mode (SB), and
the control element (8) is connected to the sensors (20).

### LIST OF REFERENCE SYMBOLS

1 motor vehicle
2 vehicle interior
3 air conditioner
4 main channel
5 air
5′ dehumidified air
5″ humidified air
6 vehicle's exterior
7 dehumidifier
8 control unit
9 control line
10 dehumidifying element
11 air supply channel
12 exhaust air channel
13 shutter system
14 shutter unit
15 element
16 heater
17 ceramic element
18 PTC element
19 coating
20 sensors
21 actuator
22 shutter
23 main airflow
24 first subsidiary airflow
25 second subsidiary airflow
SZ1 first setting
SZ2 second setting
SS1 first setting
SS2 second setting
H heater
K cooler
SB sorption mode
DB desorption mode

1-14. (canceled)

15. An air conditioner for the interior of a vehicle, comprising a main channel for conducting air in a main airflow to the vehicle interior,
further comprising a dehumidifier configured for dehumidifying a first subsidiary airflow to the main airflow in the main channel, the dehumidifier further comprising at least one dehumidifying element configured for dehumidifying the first subsidiary airflow flowing through the dehumidifier,
wherein the dehumidifying element is placed in the main channel such that the first subsidiary airflow flows through the dehumidifying element, at least during a dehumidifying mode,
wherein the dehumidifier further comprises an air supply channel for the dehumidifying element, the air supply channel conducts the first subsidiary airflow from the dehumidifying element to the main channel, and an exhaust air channel, the exhaust air channel conducts a second subsidiary airflow from the dehumidifying element to an exterior of a vehicle that includes the air conditioner,
wherein the dehumidifying element is configured to be operated in a sorption mode (SB) to accumulate moisture, in which the dehumidified air in the first subsidiary airflow is conducted through the air supply channel to the main channel, and to be operated in a desorption mode (DB), in which the moisture is discharged, such that the humidified air in the second subsidiary airflow is discharged through the exhaust air channel into the vehicle's exterior.

16. The air conditioner according to claim 15, wherein the air conditioner is configured to be operated in a dehumidifying mode during a recirculating mode, and/or during a fresh air mode, and/or during a mixed air mode, in which
the first subsidiary airflow and second subsidiary airflow branch off from the main airflow,
the first subsidiary airflow, containing the dehumidified air, is returned to the main airflow downstream of the dehumidifier, and
the second subsidiary airflow, containing the humidified air is discharged into the vehicle exterior.

17. The air conditioner according to claim 15, wherein the air conditioner comprises a control unit that is connected to the dehumidifier, and
the control unit is configured to operate the air conditioner in the dehumidifying mode in which the dehumidifying element is switched back and forth between the sorption mode (SB) and the desorption mode (DB).

18. The air conditioner according to claim 17, wherein
the dehumidifier contains at least two such dehumidifying elements that are a first dehumidifying element and a second dehumidifying element, both of the first dehumidifying element and the second dehumidifying element are connected at an intake end of the main channel,
the first dehumidifying element and the second dehumidifying element are each connected at the outlet end to at least one such air supply channel and at least one such exhaust air channel,
the dehumidifier further comprises a shutter system configured for regulating the air supply channels and exhaust air channels, that can be switched back and forth between a first setting (SZ1) and second setting (SZ2),
in the first setting (SZ1), the first dehumidifying element is connected to the air supply channel, while the second dehumidifying element is connected to the exhaust air channel,
in the second setting (SZ2), the second dehumidifying element is connected to the air supply channel, while the first dehumidifying element is connected to the exhaust air channel.

19. The air conditioner according to claim 18, wherein
the control unit is configured to switch the shutter system back and forth between the first setting (SZ1) and second setting (SZ2) in the dehumidifying mode,
the control unit is also configured to operate the first dehumidifying element in the sorption mode (SB) and the second dehumidifying element in the desorption mode (DB) when in the first setting (SZ1) in the dehumidifying mode, while operating the first dehumidifying element in the desorption mode (DB) and the second dehumidifying element in the sorption mode (SB) when in the recirculating mode in the second setting (SZ2).

20. The air conditioner according to claim 18, wherein the first and second dehumidifying elements each have separate air supply channels and separate exhaust air channels at their respective outlet ends, such that the first dehumidifying element has a first air supply channel and first exhaust air channel while the second dehumidifying element has a second air supply channel and second exhaust air channel.

21. The air conditioner according to claim 20, wherein
the shutter system has two separate shutter units, a first shutter unit and second shutter unit, for regulating the first air supply channel and first exhaust air channel, and a second shutter unit for regulating the second air supply channel and second exhaust air channel,
the first and second shutter units are each configured to be be shifted back and forth between a first position (SS1), in which its air supply channel is open and the respective exhaust air channel is closed, and a second position (SS2), in which the respective air supply channel is closed, and its exhaust air channel is open.

22. The air conditioner according to claim 21, wherein the control unit is configured to shift the first shutter unit to the first position (SS1) and the second shutter unit to the second position (SS2) to obtain the first setting (SZ1), and to shift the first shutter unit to the second position (SS2) and the second shutter unit to the first position (SS1) to obtain the second setting (SZ2).

23. The air conditioner according to claim 18, wherein
the first and second dehumidifying elements each contain hygroscopic elements with electric heaters through which air can flow, and
the heaters are switched off in the sorption mode (SB) and switched on in the desorption mode (DB).

24. The air conditioner according to claim 23, wherein the element is ceramic.

25. The air conditioner according to claim 23, wherein the element is a semiconductor element with a positive temperature coefficient.

26. The air conditioner according to any of the claims 23, wherein the element has a hygroscopic coating.

27. The air conditioner according to claim 18 wherein the control unit is configured to
switch the shutter system back and forth between the first setting (SZ1) and second setting (SZ2) at a predefined switching frequency when in the dehumidifying mode, and/or
switch the shutter system back and forth between the first setting (SZ1) and second setting (SZ2) based on a degree of sorption of the first and second dehumidifying elements are each operated in the sorption mode (SB) when in the dehumidifying mode, and/or
switch the shutter system back and forth between the first setting (SZ1) and second setting (SZ2) based on the humidity in the air in the air supply channel for the first and second dehumidifying elements operated in the sorption mode (SB) when in the dehumidifying mode.

28. The air conditioner according to claim 27, wherein
the dehumidifier further comprises sensors for detecting the degree of sorption in the first and second dehumidifying elements operated in the sorption mode (SB), and/or to detect the humidity in the air in the air supply channel for the first and second dehumidifying elements operated in the sorption mode (SB), and
the control element is connected to the sensors.
